(19) United States
(12) Patent Application Publication
(10) Pub. No.: US 2014/0350525 A1
(43) Pub. Date: Nov. 27, 2014

(54) E-Z Dose-Pensing

(71) Applicants: Warren Robinson, Elkins Park, PA (US); Chandricka Carr, Elkins Park, PA (US)

(72) Inventors: Warren Robinson, Elkins Park, PA (US); Chandricka Carr, Elkins Park, PA (US)

(21) Appl. No.: 14/285,554

(22) Filed: May 22, 2014

Related U.S. Application Data
(60) Provisional application No. 61/826,386, filed on May 22, 2013.

(51) Int. Cl. A61J 3/00; B65D 51/28; A61J 1/20

(52) U.S. Cl. CPC A61J 3/00; A61J 1/2093; B65D 51/2821; A61J 2001/2027
USPC 604/514; 206/222

(57) ABSTRACT

E-Z Dose-pensing, is an improved assistive device for mixing and compounding medications Two different types of dispensers are provided. Liquid material is placed into the cap of the cup dispenser and solid material is placed into an inner chamber, when a twist seal is broken, the solid and liquid materials mix together. For the syringe dispenser, liquid is placed into an elongate tube and when the plunger of the syring is pushed, the liquid is pushed into a chamber having solid material, is shaken to mix the liquid an solid.

### CLAIM OF PRIORITY

This patent application claims priority under 35 USC 119 (e) (1) from U.S. Provisional Patent Application Ser. No. 61/826,386 filed May 22, 2013, of common inventorship herewith entitled, “E Z Dose-pensing.”

### FIELD OF THE INVENTION

The present invention pertains to the field of pharmaceuticals, and more specifically to the field of compound medications.

### BACKGROUND OF THE INVENTION

The prior art has put forth several designs for mixing and compounding medications. Among these are:

U.S. Pat. No. 8,109,917 to Rourke M. Yeakley and Charles Leslie Floyd, Jr. describes a dispenser having a first chamber containing a first fluid and a second chamber containing a second material. Each chamber has screw threads that are selectively joinable so the first and second chambers are twistable relative to one another. The first chamber includes an open top end that is covered with a breakable membrane before use. A breaker ring is located within the second chamber and configured to break the breakable membrane when the dispenser is transitioned between an extended position and a compact position. In the compact position with the breakable membrane broken, the first fluid and second material form a mixture that dispensed through an opening in an openable tip.

U.S. Pat. No. 5,244,120 to John R. O'Meara describes a dual compartment container assembly which comprises a container having two adjacent compartments defined by a common wall and a pair of outer arcuate walls. The container has a filling end which is sealed after contents are placed in the compartments and has a discharge end at the other axial end of the container. The common wall is pleated to have an S shaped curved first width prior to filling and a straightened longer width forming a straight line seal at a point spaced from the filling end. The outer walls and the common wall terminate axially at the filling end to provide a filling end seal region. Pressure forms the seal at the filling end by joining the ends of the outer walls, and the seal includes the end of the common wall in the seal. The outer walls are joined with the common wall to form axially aligned pivotal junctions to define bellows by causing the compartments to taper outwardly from a point axially inward from the straight line seal. The bellows form no part of the straight line end seal It is preferred that the straight line seal is a heat seal.

U.S. Pat. No. 4,950,237 to Paul Henault describes a dual chambered vial equipped with a dislodgeable stopper device between the two chambers, whereby components of a mixture are maintained in separate chambers until comingling is desired. The stopper is dislodged by means of a plunger activated by depression of flexible walls of one chamber.

None of these prior art references describe the present invention.

### SUMMARY OF THE INVENTION

It is an object of the present invention to provide an assistance device for pharmacists to improve mixing and dispensing of compound medications.

### BRIEF DESCRIPTION OF THE DRAWINGS

FIG. 1 is an illustrative view of a cup dispenser for adult patients showing a cap, twist break seal, solid component, solution, rubber seal, soft plastic, and hard plastic.

FIG. 2 is an illustrative view of a syringe dispenser for infants, small children and geriatric patients showing a push down top, solution and solvent or powder.

### DETAILED DESCRIPTION OF THE INVENTION

For millions of people, manufactured medications are unable to meet their specific health care needs. Specialized dosing or compounding is the only way to successfully administer medication for a wide variety of conditions. Compounding involves personalized medication solutions that mixed by trained and licensed pharmacists. Compounding is performed for medically necessary reasons such as changing the medication form from a solid pill to a liquid, eliminating a nonessential ingredient because a patient is allergic to it, or obtaining a specific and exact dosage amount. Patients require specialized dosing for various reasons. Patients may have pediatric or geriatric issues, multiple health care issues that impact a drug's absorption or elimination or allergic reactions to inert ingredients such as binders or dyes in commercially available products. Patients may have difficulty absorbing medication by traditional medication deliveries such as swallowing pills. Pharmacists must perform compounding to an accurate precision to ensure the well being of patients being treated. Compounding is an arduous and time consuming process that is prone to human error. Meticulously converting solid pills into a liquid form, or adding safe and palatable flavoring to a pediatric medication is strenuous, stressful and time consuming, even for extremely experienced pharmacists.

The present invention, hereinafter referred to as E-Z Dose-pensing, is an improved assistive device for mixing and compounding medications such as antibiotics, pediatric medications, and other solutions that require a compounding process. E-Z Dose-pensing provides professionally trained pharmacists with a more effective and accurate means of executing appropriate compounding while facilitating easy patient and caregiver usage of such medications. E-Z Dose-pensing expedites the compounding process and ensures accurate mixtures and dosage dispensation.

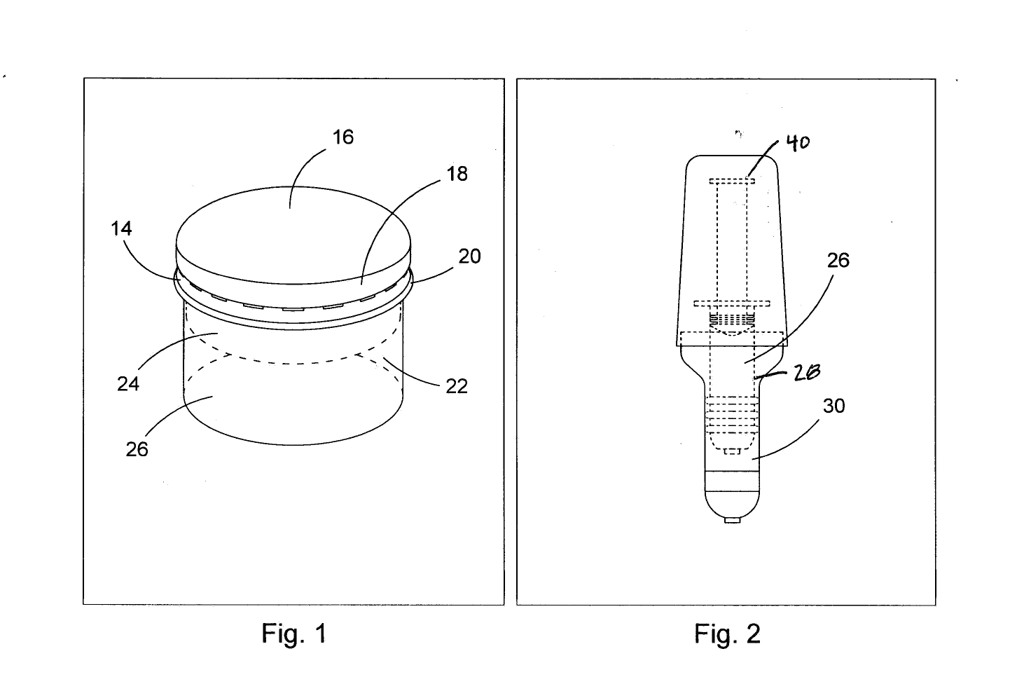

The present invention is a compact device configured to house each specific calculation of a certain medication. The formulated ingredients are reconstituted or mixed and compounded with a simple pull, turn and shake for the cup dispenser, and push and shake for the syringe dispenser. Once the compounding process is completed, E-Z Dose-pensing is ready to use immediately, eliminating the need to refrigerate. A pharmacist distributes an E-Z Dose-pensing to a patient with the mixed medication inside. The patient or caregiver then uses the present invention to dispense the correct dosage accurately. Two different types of dispensers, a cup (FIG. 1) and a syringe (FIG. 2), are available for adults and children. The adult cup dispenser measures approximately two inches in diameter by one and one half inches in height. The adult's dispenser is manufactured with hard and soft plastic and is amber in color or tinted to resist light penetration. The children's syringe dispenser measures approximately four inches in length. The children's syringe contains child safety caps.

The cup dispenser shown in FIG. 1 comprises a cap 16, into which is placed liquid material such as H2O in housing 18. Immediately below housing 18 is a twist break seal 14, and below the twist break seal 18 is a rubber seal 20. The liquid material is placed into the housing 18 and the cap 16 is secured onto the dispenser. The cap 16 is pulled and twisted, breaking the twist break seal, allowing the liquid material to fall into the soft plastic chamber 24. Solid material such as powder or tablets in solution 26 is housed in cup 22. When the device is shaken, solid material falls from soft plastic chamber 24 and mixes with solution 26 housed in cup 22. Cap 16 is unscrewed, and the mixed medication is ready for ingestion.

The syringe dispenser is shown in FIG. 2. Solution 26 is placed inside inner elongate tube 28. When plunger 40 is pushed down, solution 26 exits into chamber 30 which contains solid or powder medication to be mixed.

An antibiotic medication such as amoxicillin is commonly compounded for pediatric use through a suspension process. When pediatric amoxicillin is reconstituted using E-Z Dose-pensing, the ingredients are divided properly and placed within the device. A patient or caregiver needs only to turn and shake the present invention when it is time to dispense the medication. In this manner, all of the amoxicillin is mixed and taken at that moment, eliminating the need for refrigeration and the worry about expiration.

Ensuring expedient mixing and extractions, the E-Z Dose-pensing alleviates labor and time common to standard methods of specialized dosing preparations and eliminates worry of mistakenly calculating ingredient amounts. E-Z Dose-pensing greatly reduces risk of spillage and waste of a costly medication. Compact and lightweight, E-Z Dose-pensing is stored between uses and is transportable in a purse, backpack or carryon bag if a medication is needed while away from home. E-Z Dose-pensing provides pharmacists, patients, hospitals, nursing homes, clinics and private practice physicians with an invaluable accessory for patient care.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An assistance device for pharmacists or patients to improve mixing and dispensing of compound medications, comprising: a cup dispenser comprising a cap, wherein the cap comprises a housing capable of receiving liquid material, further comprising immediately below the housing a twist break seal, and below the twist break seal a rubber seal, below the rubber seal a soft plastic chamber, below the soft plastic chamber a cup which is capable of housing solid material, wherein the cap is capable of being pulled and twisted, thereby breaking the twist break seal to allow the liquid material to fall into the soft plastic chamber, and wherein the solid material is capable of falling from the soft plastic chamber and mixing with liquid material in the cup when the device is shaken.

2. A method for mixing and dispensing of compound medications comprising: placing liquid material into a cup, securing a cap onto a dispenser, pulling and twisting the cap, allowing the liquid material to fall into a soft plastic chamber housing solid material such as powder or tablets, shaking the device, allowing solid material to fall from the soft plastic chamber and mix with liquid material housed in the cup, unscrewing the cap, and administering the mixed medication to a person in need of medication.

3. An assistance device for pharmacists or patients to improve mixing and dispensing of compound medications, comprising: a syringe having a plunger which travels inside an elongate tube and an outer chamber capable of receiving solid material, further wherein the elongate tube is capable of receiving a liquid solution, so that when the plunger is pushed down, liquid solution exits from the elongate tube and into the outer chamber and mixes with solid material, when the device is shaken.

4. The assistance device for pharmacists or patients to improve mixing and dispensing of compound medications of claim 1, wherein the device is tinted or amber in color to resist light penetration.

5. The assistance device for pharmacists or patients to improve mixing and dispensing of compound medications of claim 3, wherein the device is tinted or amber in color to resist light penetration.

6. The assistance device for pharmacists or patients to improve mixing and dispensing of compound medications of claim 1, wherein the device measures approximately two inches in diameter by one and one half inches in height.

7. The assistance device for pharmacists or patients to improve mixing and dispensing of compound medications of claim 3, wherein the device measures approximately four inches in length.

8. The assistance device for pharmacists or patients to improve mixing and dispensing of compound medications of claim 3, further comprising a child safety cap.

9. The assistance device for pharmacists or patients to improve mixing and dispensing of compound medications of claim 1, wherein the device is autoclavable.

10. The assistance device for pharmacists or patients to improve mixing and dispensing of compound medications of claim 1, wherein the device is disposable.

11. The assistance device for pharmacists or patients to improve mixing and dispensing of compound medications of claim 3, wherein the device is autoclavable.

12. The assistance device for pharmacists or patients to improve mixing and dispensing of compound medications of claim 3, wherein the device is disposable.
